(19) United States
(12) Patent Application Publication
(10) Pub. No.: US 2004/0039607 A1
(43) Pub. Date: Feb. 26, 2004

(54) Medication and specimen management system

(76) Inventors: Steve Savitz, Teaneck, NJ (US); Neil Moore, Hamilton, OH (US); Michael Soares, Ridgewood, NJ (US); Renato Cataldo, St. Louis, MO (US)

Correspondence Address: BECTON, DICKINSON AND COMPANY, 1 BECTON DRIVE, FRANKLIN LAKES, NJ, 07417-1880, US

(21) Appl. No.: 10/647,038

(22) Filed: Aug. 22, 2003

Related U.S. Application Data
(63) Continuation of application No. 09/428,003, filed on Oct. 27, 1999, now abandoned.
(60) Provisional application No. 60/106,411, filed on Oct. 30, 1998.

(51) Int. Cl. G06F 17/60

(52) U.S. Cl. 705/3

(57) ABSTRACT

A system and method to manage information relating to patients in a hospital environment. The system includes a plurality of information processing systems for processing information relating to a patient in the hospital, with each of the information processing systems being associated with a discrete hospital function. One or more portable data terminals for receipt and transmission of information relating to the patient are further provided. A control server is provided to communicate with each of the information processing systems and the portable data terminals, for transfer of information relating to the patient between the information processing systems and the portable data terminal. As such, the portable data terminal is capable of periodic communication with the control server for intermittent interfacing with the information processing systems for receiving information relating to the patient from the information processing systems through the control server, and for transferring data relating to the patient from the portable data terminal to the information processing systems through the control server.

### BACKGROUND OF INVENTION

1. Field of Invention

The present invention is relates to management of medication and specimens and procedures and patient information in a hospital environment. More particularly, the present invention relates to an improved system for integrating and managing information and data with respect to specimen collection, medication delivery and administration procedures.

2. Description of Related Art

In portable systems for identifying articles and printing identification relating to specific articles, an article is encoded by providing the article with a label having a bar code or similar identification thereon. A scanner, such as a laser scanner or an optical scanner, is capable of reading the encoded bar code information from the article, and processing the information.

Such portable systems are particularly useful in hospital environments, with respect to medication distribution and specimen sample collection procedures. For example, in a hospital environment, a phlebotomist is provided with a list of patients requiring blood collection for testing. The phlebotomist travels to the bedside of each patient requiring blood collection, draws a blood sample, and appropriately labels the sample with the patient identification and testing to be conducted.

Encoded identification of patients and testing procedures has simplified such collection procedures, and ensures proper correlation of the collected sample with the appropriate patient for analysis in a laboratory.

While portable data collection systems and devices are convenient for specimen collection management, it may be more efficient to integrate a plurality of hospital information systems such as laboratory systems, pharmacy systems, hospital administration systems, and the like. Such information and data is often stored in various hospital information systems, and communication between such systems can be difficult.

Accordingly, a need exists for a system which is capable of integrating and managing a plurality of hospital information systems, and transmitting data and information between such hospital information systems and portable devices for use at the patient's bedside.

### SUMMARY OF THE INVENTION

The present invention is a system for managing and administrating information. Desirably, the present invention is a system for management and administration of patient information in a hospital environment where information may be correlated between a plurality of information processing systems in a hospital environment.

Preferably, the system of the present invention includes a plurality of information processing systems for processing information relating to a patient in the hospital, with each of the information processing systems being associated with a discrete hospital function. The information processing systems may be selected from the group consisting of hospital information systems, laboratory information systems, pharmacy information systems, radiology information systems and accounting information systems. One or more portable data terminals for receipt and transmission of information relating to the patient are further provided. Also, a control server is in one-way or two-way communication with each of the information processing systems as well as the portable data terminals, for transfer of information relating to the patient between the information processing systems and the portable data terminal. The portable data terminal is capable of periodic communication with the control server for intermittent interfacing with the information processing systems for receiving information relating to the patient from the information processing systems through the control server, and for transferring data relating to the patient from the portable data terminal to the information processing systems through the control server. Information such as sampling data, medication administration and the like is communicated. Such communication is preferably accomplished by radio frequency transmission, ethernet, or serial connection.

The system may further include a terminal server or docking station associated with the portable data terminals, with the terminal server or docking station capable of providing two-way communication between the portable data terminals and the control server. Moreover, a local area network may be incorporated for communicating between the plurality of portable data terminals and the control server.

Preferably, the portable data terminal includes a microprocessor, reading means such as a bar code scanner, and printing means, with the reading means capable of reading identification information from a patient identification code and printing a corresponding information label, and the microprocessor capable of storing data relating to the identification information and the printed information label for transmission to the information processing systems through the control server.

The system of the present invention may further include means for gathering and managing information relating to the patient in the hospital comprising a plurality of information processing systems for processing information relating to the patient. The system includes a portable data terminal for collecting data relating to assessment of the patient, for example gathering of vital signs and the like. A control server in two-way communication with the information processing systems and the portable data terminal is further provided for transferring the data gathered from the patient by the portable data terminal to the information processing systems.

The system of the present invention further includes a method for managing patient information relating to a patient in the hospital. The method includes providing a plurality of information systems for processing-information relating to patient and one or more portable data terminals. Information from the information systems is transferred to a control server, and accessed by the portable data terminals through the control server. Procedures are then conducted in accordance with the information accessed by the portable data terminals, and data relating to the procedures conducted is stored in the portable data terminals. Such stored data is then transferred from the portable data terminals to the information processing systems through the control server. Moreover, the transferring of information and data may be accomplished through a terminal server or docking system connected between the control server and the portable data terminal.

### DESCRIPTION OF THE DRAWINGS

FIG. 1 illustrates a block diagram of the patient information management system of the present invention.

FIG. 2 is a perspective view of a portable data terminal of the present invention.

FIG. 3 illustrates the patient information management system of the present invention.

FIG. 4 illustrates the patient information management system of the present invention.

FIG. 5 illustrates the patient information management system of the present invention.

FIG. 6 is a flow chart of the method to the present invention.

### DETAILED DESCRIPTION

The system of the present invention is described herein for use in a hospital environment. It is understood, however, that the system is useful for a large variety of environments, and is therefore not meant to be limited to a hospital environment. Furthermore, it is understood that each information system as discussed herein may be physically located within the laboratory within a hospital, or may be located outside of the hospital such as an outside laboratory contracted to conduct analyses for the hospital.

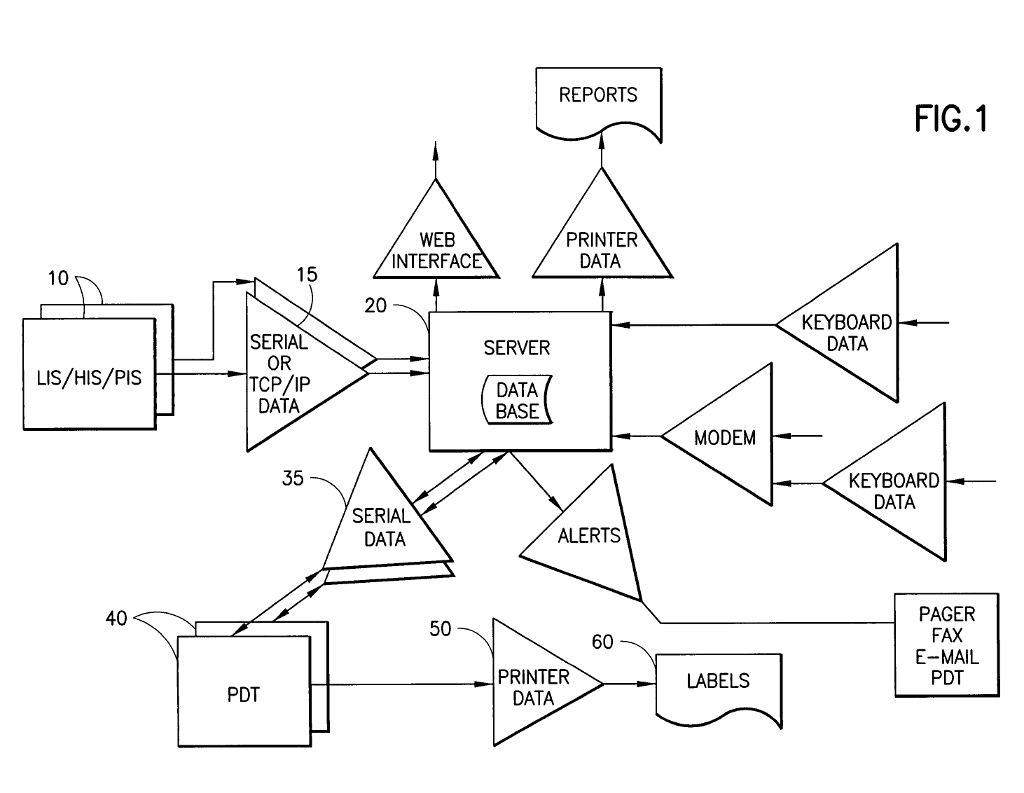

The system of the present invention is illustrated in the block diagram of FIG. 1. The system includes an information processing system, preferably a plurality of information processing systems 10, for processing and managing information. The information processing systems may be, hospital administration systems, laboratory information systems, pharmacy information systems, accounting information systems, and the like. The hospital administration system may include an entire patient history file listed for a specific patient, including all medical records, for a particular visit and/or over the lifetime of the patient. The laboratory information system may include information relating to specific laboratory analyses which have been conducted on samples of a particular patient. The pharmacy information system may include information relating to medications which have been prescribed and/or administered for a particular patient. The accounting information system may include accounting information relating to all procedures and tests conducted on a particular patient for billing and insurance purposes.

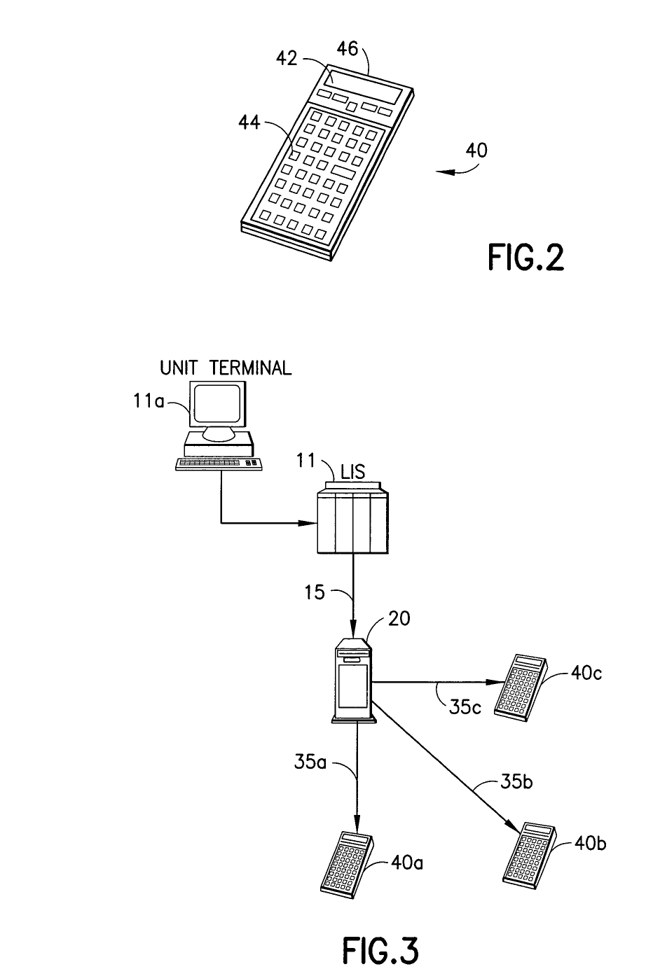

The system of the present invention further includes one or more portable data terminals 40 as shown in FIGS. 1 and 2. Portable data terminal 40 can be any type of portable device useful in gathering and transmitting information, such as information relating to patient well-being within a hospital environment. The portable data terminal includes a microprocessor having memory for storage of information and data. Portable data terminals 40 includes a keypad 44 for manual entry of data by a user, a display 42 for visual communication with a user. Portable data terminal 40 also includes a bar code scanner 46 for reading information, including patient identification information from a patient identification bracelet as well as container information from a manufacturing identification on a sample container label or medication container. Portable data terminal 40 may also include printing means, for printing a label for attachment to a sample container, including information such as patient identification information or laboratory analyses to be conducted on the sample.

A control server 20 in two-way communication with each of information processing systems 10, and with each of the one or more portable data terminals 40. Through such communication, the control server 10 can manage information relating to the patient by transferring such information between each of information processing systems 10, between each of portable data terminals 40, as well as between information processing systems 10 and portable data terminals 40.

Two-way communication between control server 20 and information systems 10 can be any type of communication link for transfer of information and data. As shown in FIG. 1, an information processing system serial connection 15, serially links information processing systems 10 with control server 20 for transmission of data. The two-way communication between control server 20 and portable data terminals 40, as terminal serial connection 35, can be the same or different type of communication link for transfer of information and data. Such a connection can be an electrical connection, such as an ethernet connection, a telephone connection using a data-over-voice modem, a wireless connection such as a radio frequency transmission, and the like.

Information processing systems 10 may further include one or more peripheral devices in communication therewith. Information processing systems 10 may include unit terminals for input of data, printers for generation and printing of reports, communication links such as pagers, printers, facsimile machines, and other similar peripheral elements which can be used in administration and management of information within the system. Control server may also include peripheral devices and elements for administration and management of information within the system.

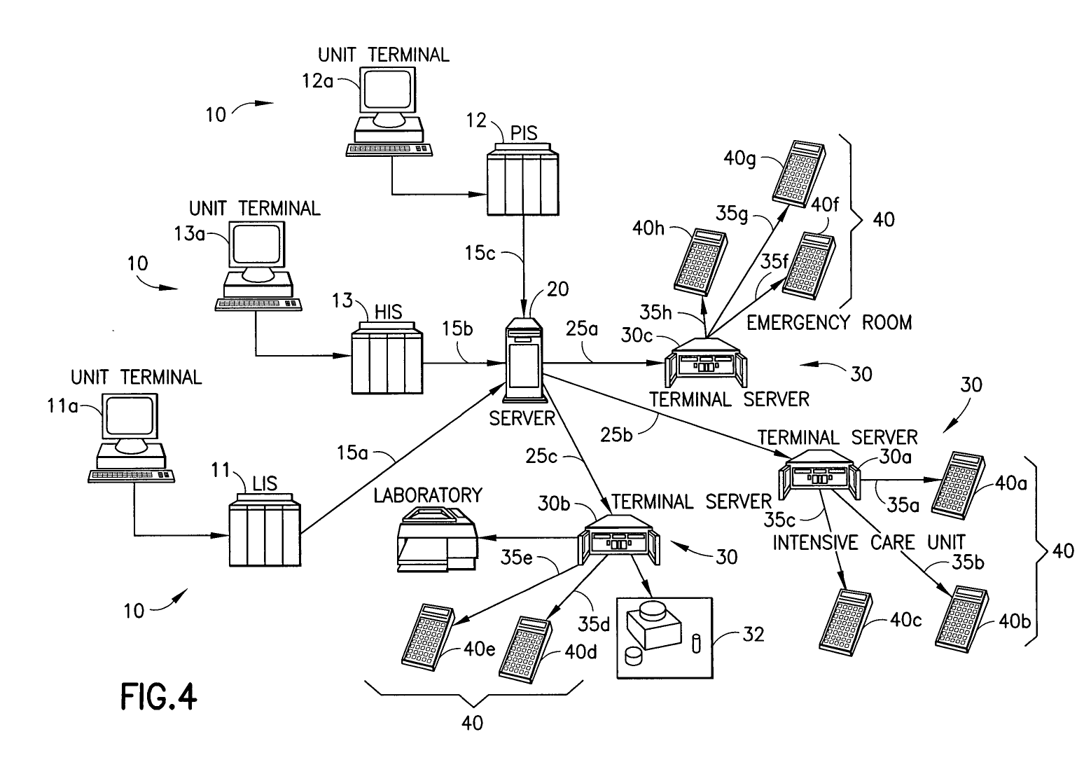

Interconnection of the components of the system of the present invention is shown in FIGS. 3, 4 and 5. FIG. 3 shows an information processing system 10 that includes a laboratory information system 11 (LIS) in two-way communication with control server 20. Information and data is entered into laboratory information system 11 by a laboratory terminal 11a. Such information and data is then processed and stored in laboratory information system 11.

Multiple portable data terminals 40, further depicted as 40a, 40b and 40c, are also included in the system, in two-way communication with control server 20. Such multiple portable data terminals 40 are capable of interfacing and transferring information between information processing systems 10 and portable data terminals 40 through control server 20. The two-way communication link is established between control server 20 and each of portable data terminals 40 using a docking station, in which portable data terminals 40 can be removably “docked” for linking with control server 20 for periodic interfacing therewith, thereby providing a direct two-way communication link for transfer of information and data therebetween.

Each of portable data terminals 40a, 40b and 40c are capable of transport within a hospital environment, for example to a patient's bedside for assessment of patient medical characteristics and conditions. For example, portable data terminals 40a, 40b and 40c may be capable of gathering and storing data relating to procedures conducted, such as gathering of vital signs of a patient including body temperature, blood pressure, and the like, confirmation of sampling of patient specimens, or may be capable scanning identification information of a patient from a bar code bracelet for printing of an identification label for a specimen container label or verifying the correct administration of a medication.

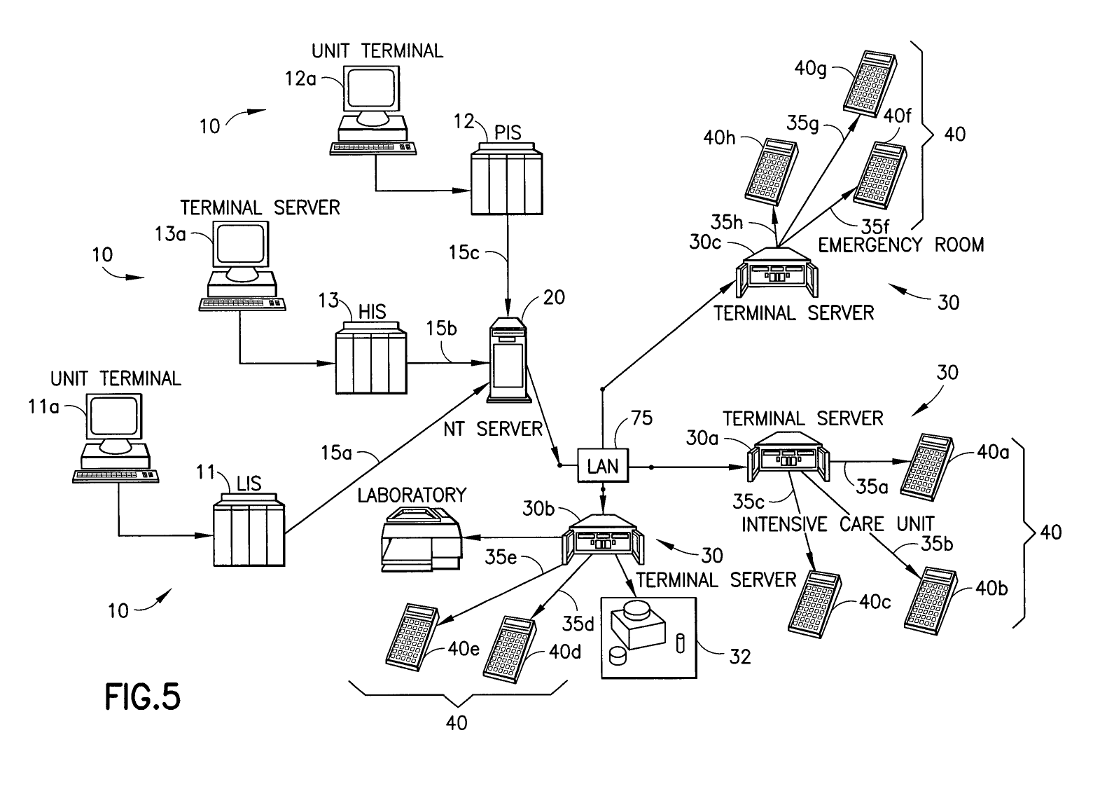

In a further embodiment as depicted in FIG. 4, a plurality of information processing systems 10 may be included in the system, including laboratory information system 11 (LIS), pharmacy information system 12 (PIS) and hospital administration system 13 (HIS). Each of these information processing systems 11, 12 and 13 may include one or more unit terminals such as laboratory terminal 11a, pharmacy terminal 12a, and hospital terminal 13a, such as a user station with a keyboard for data entry of relevant system information by a user. Each of these plurality of information systems is in two-way communication with control server 20 through information serial connections 15a, 15b and 15c, respectfully. Such information serial connections 15a, 15b and 15c provide direct, two-way communication of information and data between laboratory information system 11, pharmacy information system 12, and hospital administration system 13. Moreover, each of laboratory information system 11, pharmacy information system 12, and hospital administration system 13 are capable of intercommunicating with each other through the communication link maintained through control server 20.

Portable data terminals 40, further depicted as 40a, 40b, 40c, 40d, 40e, 40f, 40g and 40h, are provided as described above for gathering of data and information relating to patients within a hospital environment. These portable data terminals are in two-way communication with control server 20. Such two-way communication may be established by a direct communication. Preferably, such two-way communication extends through terminal servers 30 serving a specific hospital facility, for example, terminal server 30a for an intensive care unit, terminal server 30b for a hospital laboratory, and terminal server 30c for an emergency room. In such an embodiment, control server 20 is linked to terminal server 30a, 30b, and/or 30c through terminal serial connection 25a, 25b, and 25c, respectively. Portable data terminals 40a, 40b, 40c, 40d, 40e, 40f, 40g and 40h are in two-way communication with the respective terminal server 30a, 30b and 30c, thereby providing two-way communication between control server 20 and each of portable data terminals 40a, 40b, 40c, 40d, 40e, 40f, 40g and 40h through terminal servers 30a, 30b and 30c. Preferably, such two-way communication between control server 20 and each of portable data terminals 40a, 40b, 40c, 40d, 40e, 40f, 40g and 40h is established through a docking station as discussed above, with the docking station located at terminal servers 30a, 30b and 30c.

Moreover, terminal servers 30a, 30b and 30c are preferably located at various locations within the hospital environment to provide ease of access. For example, terminal server 30a which serves an intensive care unit in a hospital may be located at a central nursing station for that intensive care unit. Such an arrangement is particularly useful when terminal server 30a includes a docking station for interfacing with portable data terminals 40a, 40b and 40c, in that when orders are received by portable data terminals 40a, 40b and 40c through terminal server 30a, as will be discussed in more detail herein, the nursing station can be immediately notified of such orders at a centralized location.

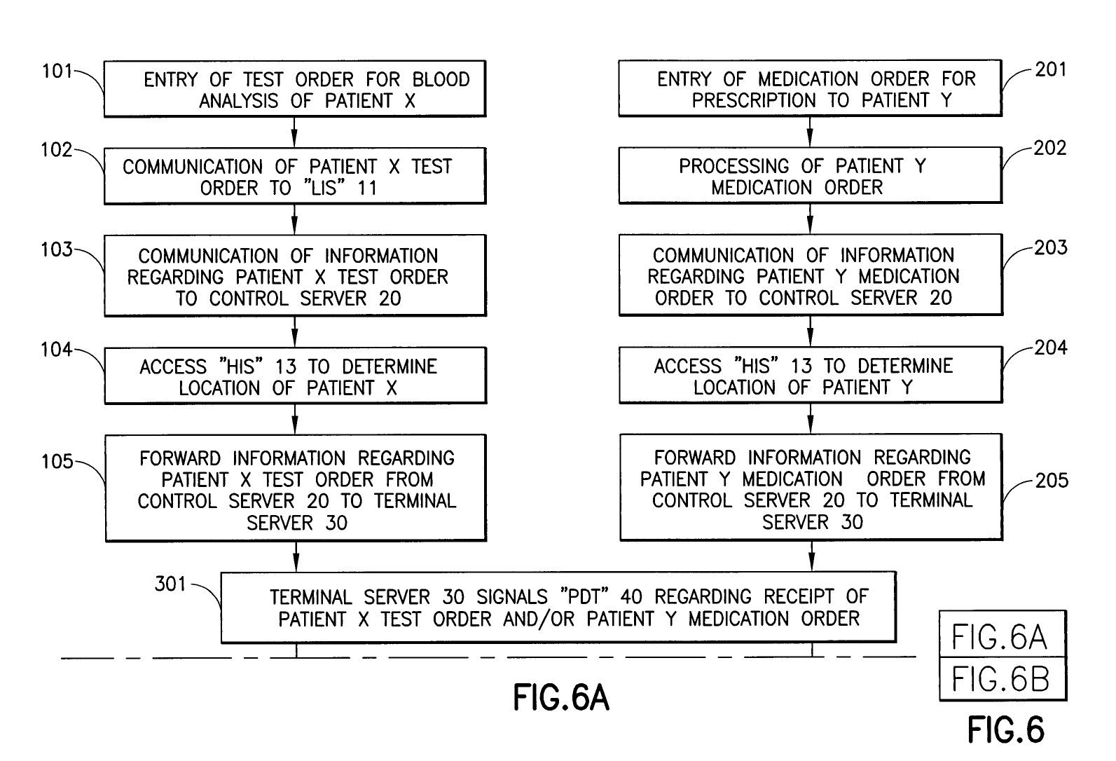

In an alternate embodiment shown in FIG. 5, the two-way communication between control server 20 and each of terminal servers 30a, 30b, and 30c may be accomplished through a local area network 75, capable of interconnecting and networking a plurality of terminal servers for communication there between and independently with control server 20.

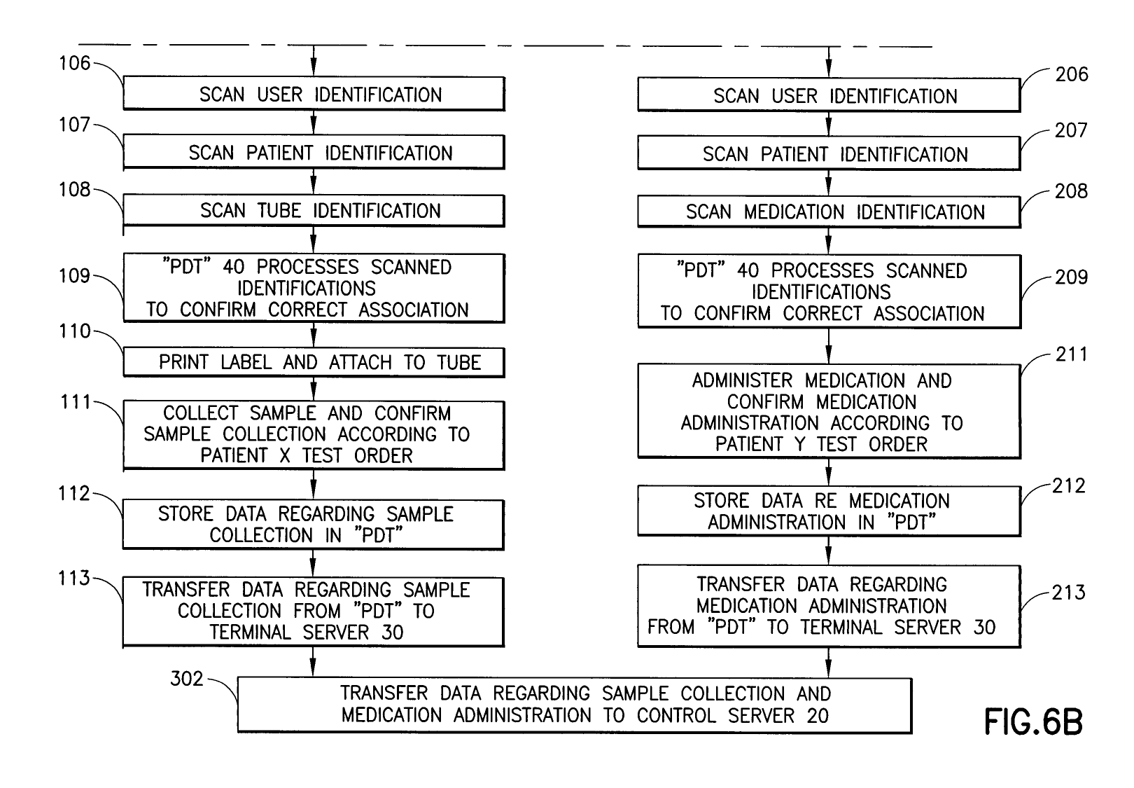

Referring to FIG. 4, the system will now be described in terms of a preferred method of use, with additional reference to the flow chart of FIG. 6. In a typical hospital environment, a patient history file is maintained for each patient within the hospital environment in a hospital information system, such as hospital information system 13. Such a patient history file may include an entire medical history of a patient, or may include only current information relating to a current patient hospital admission. Such patient history file is typically input into the hospital information system 13 by user data entry at hospital terminal 13a. For example, upon admission to the hospital, a clerk may input various medical information into the hospital information system 13, such as patient identification information, allergies, medical history, etc. At the time of patient admission, the patient is typically provided with a patient identification, such as a bar code identification bracelet to be worn by the patient, which includes patient identification information encoded thereon. Such patient identification information is further stored in the patient history record of hospital information system 13.

Typically, during a patient's hospital stay, it is necessary to obtain biological samples from a patient in order to conduct various analytical tests. In the present system, when such a test is ordered, a test order is entered into laboratory information system 11. Such test order may be entered directly into laboratory information system 11 through laboratory terminal 11a, or may be entered into hospital information system 13 through hospital terminal 13a, and communicated to laboratory information system 11 through control server 20. For example, as shown at step 101 of FIG. 6, a doctor may order a test order for a blood analysis of Patient X, which test order is entered into hospital information system 13 to maintain a complete record of all tests performed on Patient X. Further, the test order is communicated to laboratory information system 11 for completion of the test order for a blood analysis of Patient X, as in step 102.

Information relating to the test order for a particular patient or patients is then communicated to control server 20 at step 103, for forwarding to the appropriate portable data terminal 40. For example, laboratory information system 11 processes the test order for a blood analysis of Patient X, and determines that a blood sample must be obtained from Patient X in a specific blood collection container in order to conduct the appropriate blood analysis according to the test order. Laboratory information system 11 communicates information relating to the blood sample to be obtained from Patient X to control server 20, for obtaining the appropriate blood sample in the appropriate container.

Preferably, as discussed above, control server 20 communicates with portable data terminals 40a, 40b, 40c, 40d, 40e, 40f, 40g and 40h through terminal servers 30a, 30b, and 30c, which can be located at specific hospital facilities, for example at a nursing station for the intensive care unit. In this manner, communication between control server 20 and portable data terminals 40a, 40b and 40c, is accomplished through terminal server 30a, for example by using terminal server 30a as a docking station for portable data terminals 40a, 40b and 40c. Control server 20 may forward the information relating to the test order directly to all of the portable data terminals 40a, 40b, 40c, 40d, 40e, 40f, 40g and 40h within the hospital environment, preferably through the terminal servers 30a, 30b and 30c. Alternatively, control server 20 may access information from hospital information system 13 regarding the location of the patient or patients to which the test order relates, and forward the information relating to the test order only to that specific portable data terminal or terminal server at the facility location where that patient or patients are located. For example, hospital information system 13 may include information identifying the location of each patient within a hospital. When the test order for a blood analysis of Patient X is communicated to control server 20 from laboratory information system 11, control server 20 may access hospital information system 13 at step 104 to determine the location of Patient X. The hospital information system 13 can then communicate to control server 20 that Patient X is in the intensive care unit of the hospital. Control server 20 can then communicate with terminal server 30a in the intensive care unit, for transfer of information relating to the test order for Patient X at step 105.

In a similar manner, a particular patient may be prescribed certain medication during hospital visit. In the present system, information relating to the prescription and administration of such medication is entered into pharmacy information system 12 in the form of a medication order, either directly through pharmacy terminal 12a, or through hospital terminal 13a. For example, a doctor may prescribe a dosage of antibiotics to be administered to Patient Y. Such prescription is entered into the pharmacy information system 12 in the form of a medication order at step 201, and pharmacy information system can process the medication order at step 202, for example to determine whether Patient Y has any allergies to the specific antibiotic in the medication order. Alternatively, pharmacy information system 12 may communicate the medication order to hospital information system 13. With hospital information system 13 maintaining a patient history file for Patient Y, hospital information system 13 can process the medication order, for example to determine whether Patient Y has any allergies to the specific antibiotic in the medication order. Should the medication order be acceptable for Patient Y, hospital information system 13 can inform pharmacy information system 12 appropriately.

Information relating to the medication order for a particular patient or patients is then communicated to control server 20 at step 203, for forwarding to all of the portable data terminals 40a, 40b, 40c, 40d, 40e, 40f, 40g and 40h, or to the appropriate portable data terminal 40 preferably through terminal server 30a as in step 205, in a similar manner as discussed with reference to the test order.

When control server forwards information relating to the test order and/or medication order to terminal server 30a, terminal server 30a signals one or all of portable data terminals 40a, 40b and 40c docked within terminal server 30a. Such signal can be, for example, in the form of an audio signal such as an alarm, a visual signal such as a blinking light or a readout on display 42 of the portable data terminal, or a combination of both an audio and visual signal. The user, such as a nurse in the intensive care unit, detects the signal received by the portable data terminal 40a, 40b and/or 40c. The nurse then retrieves one of the portable data terminals, such as portable data terminal 40a, from the docking station of terminal server 30a for completion of the test order and/or medication order communicated to portable data terminal 40a. For example, control server 20 may forward the test order for a blood sample of Patient X and the medication order for administration of an antibiotic to Patient Y, to terminal server 30a, as both Patient X and Patient Y are located in the intensive care unit. As in step 301, terminal server 30a signals portable data terminal 40a that an order has been received. Nurse Z retrieves portable data terminal 40a from terminal server 30a. Display 42 of portable data terminal 40a indicates that a blood sample is required from Patient X and that an antibiotic is to be administered to Patient Y. Nurse Z then performs sampling rounds and medication rounds, either individually or at the same time, according to the orders communicated to the portable data terminal 40a.

In order to perform sampling rounds, display 42 of portable data terminal 40a may indicate to Nurse Z which patient requires sampling, for example Patient X. During sampling rounds, Nurse Z travels to Patient X to obtain a blood sample. At bedside, Nurse Z may first optionally scan a user identification code with scanner 46 of portable data terminal 40a at step 106. Such user identification code may be an employee identification tag bearing a bar code identification of Nurse Z. Scanner 46 of portable data terminal 40a is then used to scan a patient identification code of Patient X at step 107, such as an identification bracelet provided to Patient X during admission to the hospital. The microprocessor of portable data terminal 40a processes the scanned patient identification, and confirms that a blood sample is to be obtained from Patient X. Nurse Z then selects the appropriate collection container for the sample to be taken, such as a vacuum blood collection tube having color-coded stopper, representing a specific test to be conducted on the sample. The collection tube may include a tube identification such as a manufacturing bar code identification, which identifies the type of collection tube. Scanner 46 of portable data terminal 40a can then be used to scan the collection tube bar code identification at step 108, with the microprocessor of portable data terminal 40a processing the scanned information to confirm that the appropriate collection tube has been selected for the particular blood sample to be taken for Patient X, as in step 109. Portable data terminal 40a may then provide confirmation to Nurse Z that the correct collection tube has been selected, and that the blood sample can be collected. Nurse Z then obtains the blood sample and communicates to portable data terminal 40a that the blood sample has been collected according to the test order, as in step 111. Such communication can be in any manner, preferably by data entry by Nurse Z through keypad 44. Preferably, portable data terminal 40a includes printer 50, which prints a collection tube label at step 111 for attaching to the sample collection tube. The information printed on the collection tube label may include any appropriate sampling information, for example, patient identification, sampling date and time, user identification, tests conducted, as well as any other appropriate information, and is preferably printed in both alphanumeric form and bar code form. Such information is also preferably stored as sampling data in the memory of the microprocessor of portable data terminal 40a.

The collection tube including Patient X's blood sample is then forwarded to the laboratory for completion of appropriate analyses according to the test order. Portable data terminal 40a can then communicate the next test order to Nurse Z, or can indicate that all test orders have been completed.

In order to perform medication rounds, display 42 of portable data terminal 40a may indicate to Nurse Z which patient requires administration of medication, for example indicating that Patient Y requiring administration of antibiotics. During medication rounds, Nurse Z travels to Patient Y to administer antibiotics. At bedside, Nurse Z may again first optionally scan an employee identification tag bearing a bar code identification of Nurse Z at step 206. Scanner 46 of portable data terminal 40a then scans Patient Y's bracelet identification code at step 207. The microprocessor of portable data terminal 40a processes the scanned patient identification, and confirms that antibiotics are to be administered to Patient Y. Nurse Z then selects the appropriate antibiotics, typically provided by the pharmacy. The medication may include an identification, preferably a bar code label, which identifies the medication and may include the identification of the patient to whom the medication is to be administered. Scanner 46 of portable data terminal 40a can then be used to scan the bar code label of the medication administration container 208, with the microprocessor of portable data terminal 40a processing the scanned information to confirm that the medication is to be administered to Patient Y at step 209. Portable data terminal 40a may then provide confirmation to Nurse Z that the medication and the patient are appropriate, and Nurse Z may then administer the medication to Patient Y. After administering the medication, Nurse Z may communicate to portable data terminal 40a that the medication has been administered according to the medication order, as in step 211. Data relating to administration of the medication and completion of the medication order is then stored in the memory of the microprocessor of portable data terminal 40a.

Once all test orders and medication administrations (as well as any other procedures communicated through portable data terminal 40a) have been completed, portable data terminal 40a is returned to the docking station 30a for interfacing with control server 20 therewith. The data stored in the memory of portable data terminal 40a is then downloaded or transferred to the appropriate information system through control server 20 as in step 312. For example, sampling data relating to the blood sample collected from Patient X is transferred to control server 20, and may be communicated to laboratory information system 11. Likewise, medication data relating to administration of the antibiotic to Patient Y is transferred to control server 20, and may be communicated to pharmacy information system 12. Such data may also be communicated to other information processing systems 10, for example an accounting information system for billing purposes, a hospital information system 13 for updating of the patient history file, an inventory control system for controlling inventory of medication, equipment, and the like.

As indicated above, the blood sample collected from Patient X according to the test order is forwarded to the laboratory for analysis. Such a laboratory may be on-site within the hospital facility, or may be an outside testing laboratory. The laboratory may also include portable data terminals 40d and 40e in communication with control server 20, for example, through terminal server 30b. When the laboratory receives the blood sample, scanner 46 of one of portable data terminals 40d and 40e may be used to scan the identification label of the sample collection tube, in order catalog receipt of the sample by the laboratory and transfer data relating to receipt of the blood sample to the laboratory information system 11, through control server 20. Analytical testing according to the test order can then be undertaken by a laboratory Technician Q.

During analysis of the sample, Technician Q may scan with scanner 46 of portable data terminal 40d an employee identification code as done with Nurse Z above, in order to record data relating to the technician performing analysis of the sample. Testing of the blood sample according to the test order can then be undertaken, for example, employing various analytical instrumentation 32 within the laboratory. Preferably, such analytical instrumentation 32 is in communication with control server 20, for example through terminal server 30b. In this manner, data relating to the results of the analytical testing of the blood sample can be automatically recorded and transferred to the appropriate information processing system such as laboratory information system 11 by analytical instrumentation 32 through terminal server 30b. Alternatively, data relating to the results may be input into portable data terminal 40d by Technician Q, which data can then be transferred to the appropriate information processing system through terminal server 30b and control server 20.

What is claimed is:

1. A system for managing information relating to a patient in a hospital environment comprising:
a plurality of information processing systems for processing said information relating to said patient, each of said plurality of information processing systems being associated with a hospital function;
a portable data terminal for receipt and transmission of said information relating to said patient; and
a control server in communication with each of said plurality of information processing systems and said portable data terminal for managing said information relating to said patient.

2. A system as in claim 1, wherein said plurality of information processing systems are selected from the group consisting of hospital information systems, laboratory information systems, pharmacy information systems, radiology information systems and accounting information systems.

3. A system as in claim 1, further comprising a plurality of portable data terminals, wherein said control server is in communication between each of said plurality of information processing systems and each of said plurality of data terminals for managing said information relating to said patient.

4. A system as in claim 1, further comprising a terminal server associated with said portable data terminal, said terminal server providing communication between said portable data terminal and said control server.

5. A system as in claim 4, further comprising a plurality of terminal servers each associated with a plurality of portable data terminals, said plurality of terminal servers each providing communication between said plurality of portable data terminals and said control server.

6. A system as in claim 5, wherein said communication between said plurality of portable data terminals and said control server is conducted through a local area network.

7. A system as in claim 1, wherein said portable data terminal includes a microprocessor, reading means, and printing means, said reading means capable of reading identification information from a patient identification code and printing a corresponding information label, and said microprocessor capable of storing data relating to said identification information and said printed information label for transmission to said plurality of said information systems through said control server.

8. A system as in claim 7, wherein said reading means is a bar code scanner.

9. A system as in claim 1, wherein said plurality of information processing systems are in communication with each other through said control server.

10. A system as in claim 1, wherein said portable data terminal is capable of periodic communication with said control server for intermittent interfacing with said plurality of information processing systems for receiving said information relating to said patient from said plurality of information processing systems through said control server and for transferring data relating to said patient from said portable data terminal to said plurality of information processing systems through said control server.

11. A system as in claim 10, wherein said periodic communication is established through radio frequency communication.

12. A system for managing sample collection information and medication information relating to a patient in a hospital environment comprising:
a laboratory information processing system for processing said sample collection information relating to said patient;
a pharmacy information processing system for processing said medication information relating to said patient;
a portable data terminal for receipt and transmission of said sample collection information and said medication information; and
a control server in one-way or two-way communication with said laboratory information processing system, said pharmacy information processing system and said portable data terminal for managing said sample collection information and said medication information relating to said patient;
wherein said portable data terminal is capable of periodic communication with said control server for intermittent interfacing with said laboratory information processing system for receiving said sample collection information relating to said patient and with said pharmacy information processing system for receiving said medication information relating to said patient, and for transferring sample collection data relating to said patient taken in response to said sample collection information from said portable data terminal to said laboratory information system and for transferring medication data relating to said patient administered in response to said medication information from said portable data terminal to said pharmacy information system.

13. A system for managing information relating to a patient in a hospital environment comprising:
a plurality of information processing systems for processing said information relating to said patient;
a portable data terminal for collection of data relating to assessment of said patient and transmission of said data; and
a control server in communication with each of said plurality of information processing systems and said portable data terminal for transferring said data from said portable data terminal to said plurality of information processing systems.

14. A method for managing patient information relating to a patient in a hospital environment comprising:
a) providing a plurality of information systems for processing information relating to said patient;
b) providing a portable data terminal;
c) transferring said information from said plurality of information systems to a control server;
d) accessing said information transferred to said control server through a portable data terminal;
e) conducting procedures according to said information accessed by said portable data terminal;
f) storing data in said portable data terminal relating to said procedures conducted; and
g) transferring said stored data from said portable data terminal to said plurality of information systems through said control server.

15. A method as in claim 14, wherein said accessing step d) and said transferring step g) are accomplished through a terminal server.

16. A method as in claim 14, wherein said terminal server serves a plurality of portable data terminals for accessing information, storing data and transferring of stored data.

17. A method for managing patient sample collection information and patient medication information in a hospital environment comprising:
a) providing a laboratory information system for managing said patient sample collection information relating to sample collection and analysis;
b) providing a pharmacy information system for managing said patient medication information relating to medication prescribing and administering;
c) providing a portable data terminal;
d) transferring said sample collection information from said laboratory information system and said medication administering information from said pharmacy information system to a control server;
e) accessing said sample collection information and said medication administering information transferred to said control server through a portable data terminal;
f) collecting samples according to said sample collection information transferred to said portable data terminal and administering medication according to said medication administering information accessed by said portable data terminal;
g) storing data in said portable data terminal relating to said collected samples and said dispensed medication; and
h) transferring said stored data from said portable data terminal to said laboratory information system and said pharmacy information system through said control server.

18. A method as in claim 17, wherein said accessing step e) and said transferring step h) are accomplished through a terminal server.

19. A method as in claim 18, wherein said terminal server serves a plurality of portable data terminals for accessing information, storing data and transferring of stored data.
